(19) United States
(12) Patent Application Publication
(10) Pub. No.: US 2012/0310756 A1
(43) Pub. Date: Dec. 6, 2012

(54) SYSTEM AND METHOD FOR DISPLAYING USER'S SIGNATURE ON POS TERMINALS

(75) Inventors: MANDAR AGASHE, MAHARASHTRA (IN); SUMEET PHADNIS, MAHARASHTRA (IN)

(73) Assignee: SARVATRA TECHNOLOGIES PVT LTD., MAHARASHTRA (IN)

(21) Appl. No.: 13/405,447

(22) Filed: Feb. 27, 2012

(30) Foreign Application Priority Data
Jun. 6, 2011 (IN) 1656MUM2011

(51) Int. Cl. G06Q 20/40; G06Q 20/20

(52) U.S. Cl. 705/17; 705/21; 705/44

(57) ABSTRACT

A system and a method for authenticating financial transactions on PUS terminals have been disclosed. The system 100 authenticates the financial transaction by displaying a user's signature, at the time of a transaction, on the POS terminal. The display of the user's signature on the POS terminal not only acts as a secure access image for users to guarantee a secure payment channel but also proves the authenticity of the remote application servers associated with the financial institutions making the financial transactions at the POS terminals safer and secured.

### CROSS-REFERENCE TO RELATED APPLICATION

This application claims priority from Indian Patent Application No. 1656/MUM/2011 filed 6 Jun. 2011, the entire contents of which are specifically incorporated herein by reference.

### FIELD

This disclosure relates to the field of electronic display devices. Particularly, this disclosure relates to a system and a method that represents a customer's digital signature on monochrome display devices.

### DEFINITIONS OF TERMS USED IN THE SPECIFICATION

The term ‘payment card’ in this specification relates to a card issued to users by financial institutions like banks for purchasing goods or services. The payment cards can be at least one of an ATM card, a debit card, a credit card or a prepaid cash card.

The term ‘monochrome image’ in this specification relates to a black and white image represented by only two pixel values namely zero for white pixels present in the image and one for black pixels present in the image.

The term ‘bitmap header’ in this specification relates to an array of binary values, wherein each pixel in the array represents at least eight consecutive pixel values present in the monochrome image.

The term ‘ASCII signature format’ in this specification relates to a binary data representation of an image encoded into an ASCII string format for easy storage and transmission of the underlying image.

### BACKGROUND

Many individuals use payment cards issued to them by banks for the purpose of carrying out financial transactions. Payment cards are the preferred mode of carrying out financial transactions because they can be used at Electronic Financial Transaction terminals such as ATMs and Micro ATMs and also on terminals that facilitate cash-less payment, such as POS terminals and computers communicating with an e-payment gateway. Payment cards absolve users of the requirement of visiting a bank or using a cheque for the purpose of making a financial transaction.

Payment cards are popular amongst users because they provide the facility of cash less financial transactions, Payment cards also provide the users with the option of making financial transactions online through a computer connected to the Internet or at ATM terminals. When a payment card holder accesses an ATM terminal for the purpose of performing a financial transaction, he/she is asked to provide through the ATM terminal, the PIN (Personal Identification Number) corresponding to the payment card that is being used for the purpose of carrying out a financial transaction. Since ATM terminals make it mandatory for the customers to provide their corresponding PINs prior to carrying out a financial transaction, they associate reasonable amount of security with financial transactions by authenticating them based on the PIN entered by the user thereby making the financial transactions performed on ATM terminals secure, resistant to hacker attacks and acts of fraudulence.

The financial transactions performed on a computer machine connected to a secured payment gateway through the Internet are also governed by user specific passwords that are provided to payment card holders by payment card issuing authorities. Moreover, online payment mechanism entails usage of cryptographic techniques and encryption technique which make financial transactions performed through the Internet secure and resistant to hacker attacks and misappropriation.

However, transactions performed on Micro ATMs and POS (Point of Sales) terminals are unsecured and vulnerable to misappropriation. One of the disadvantages associated with POS terminals of prior art is that they are not designed to authenticate the financial transactions based on the signature of the payment card holder.

Even though most of the POS terminals never ask the payment card holder to provide his/he personal identification number, some of the technically advanced POS terminals make it mandatory for users to provide their PIN before proceeding with the financial transactions. In spite of being required to be authenticated using the PIN, financial transactions performed through POS terminals continue to remain unsecured and vulnerable to misappropriation since POS terminals are normally handled by third party operators and payment card users using these POS terminals might have to disclose their confidential PINs or there is a possibility that the operators assigned to operate the POS terminal might obtain the PIN corresponding to the payment card used by a user during the course of authenticating a transaction on the POS terminal.

Even in the case of a bearer cheque being presented at a bank, the signature on the bearer cheque will be verified against the specimen signature of the customer of the bank available in the bank documentation and normally the verification is performed through the naked eye by bank employees. It is only after the verification of the signature on the bearer cheque that the bearer cheque will be processed further.

Therefore in order to render the process of verifying the signature more effective and fool proof and also to provide better authentication measures to the transactions carried out through POS terminals, the present disclosure envisages a system that provides:
the facility of making use of the signatures of users as a mode of authenticating financial transactions;
payment card users with the facility of viewing their signature as a secure access image prior to confirming the financial transaction;
seamless integration with the existing any time banking mechanism; and
for secured and safer financial transaction through POS terminals.

### OBJECTS

Some of the non-limiting objects of the present disclosure, which at least one embodiment herein satisfy are as follows:

It is an object of the present disclosure to provide a facility of using the signatures of payment card holders as a mode of authenticating the financial transactions.

Another object of the present disclosure is to provide a system that facilitates verification of the signature displayed on a POS terminal with the original signature of the user, before approving a financial transaction.

Still another object of the present disclosure is to display signature of the payment card user as a secure access confirmation image on a POS terminal, at the time of performing a financial transaction.

Yet another object of the present disclosure is to make available a system that facilitates secured financial transactions,

Still further object of the present disclosure is to provide a system that can be easily integrated with existing network for providing safer and secured financial transactions.

One more object of the present disclosure is to provide a system that facilitates conversion of customer's signatures into monochrome format without creating substantial operational overheads and without requiring additional equipment or network access.

### SUMMARY

The present disclosure envisages a system for displaying users' signature for authenticating financial transactions, wherein each of the users are in possession of at least one payment card issued by a financial institution for conducting the financial transactions, the system comprising:
a server adapted to encode and store a handwritten signature image captured corresponding to a user's payment card and further adapted to retrieve and transmit the encoded signature on receiving a request corresponding to a user's payment card number; and
a plurality of POS terminals co-operating with the server and embedded with a customized application, the POS terminals adapted to receive the encoded signature in response to a payment card number transmitted for a user, further adapted to decode said encoded signature, and still further adapted to display the decoded signature and confirm the authenticity of the financial transaction in the event that the decoded signature is verified.

Typically, the server is adapted to encode the handwritten signature image using a base64 algorithm.

Preferably, the request corresponding to a user's payment card number is raised by swiping the payment card at the POS terminal.

Further, the server, each of the POS terminals and the financial institutions associated with the payment cards co-operate with each other using at least one ISO8583 based communication format.

Still further, the server comprises:
conversion means adapted to convert the handwritten signature image into a monochrome image by comparing each pixel value in the handwritten signature image with a predetermined threshold value;
bitmap header creation means adapted to receive and group at least eight consecutive bits in the monochrome image to derive a byte value and further adapted to create a bitmap header wherein the number of bits in the bitmap header equal the number of bytes contained in the monochrome image;
encoding means adapted to receive the bitmap header and subsequently construct a signature stream and further adapted to designate first two bytes of the signature stream as the height and width values and still further adapted to append the bitmap header to the signature stream and convert the signature stream into an ASCII signature format;
a central repository adapted to store the ASCII signature format corresponding to a payment card number associated with a user;
fetching means adapted to receive a request corresponding to a user's payment card number and further adapted to fetch a corresponding ASCII signature format from the central repository; and
a transceiver unit adapted to receive the handwritten signature image for the conversion means and further adapted to receive a request corresponding to a user's payment card number and subsequently transmit the ASCII signature format received from the fetching means to a corresponding POS terminal.

Furthermore, the POS terminal comprises:
a communication unit adapted to receive the encoded signature from the server on transmitting a user's payment card number and further adapted to receive a verification response from a corresponding financial institution on transmitting a user's payment card number and a monochrome equivalent of the encoded signature;
decoding means having a temporary buffer to convert the encoded signature into an array of binary data and further adapted to convert the array of binary data into a monochrome image representing a payment card holder's signature;
verification means adapted to transmit the monochrome image to a corresponding financial institution for verification along with the user's payment card number; and
display means adapted to display the monochrome image in the event that the verification response is positive.

In accordance with this disclosure there is provided a method for displaying users' signature for authenticating financial transactions, wherein each of the users are in possession of at least one payment card issued by a financial institution for conducting the financial transactions, the method comprising the following steps:
capturing a user's handwritten signature image corresponding to a payment card at a server;
encoding the captured handwritten signature at the server;
retrieving, at the time of transaction, the encoded signature on receiving a request corresponding to a user's payment card number;
decoding the encoded signature into a format suitable for display at a POS terminal; and
displaying the decoded signature and confirming the authenticity of the financial transaction in the event that the decoded signature is verified,

In accordance with this disclosure, the step of encoding the captured handwritten signature includes the following steps:
converting the captured handwritten signature into a monochrome image by comparing each pixel value in the handwritten signature image with a predetermined threshold value;
grouping at least eight consecutive bits in the monochrome image for deriving a byte value for creating a bitmap header; and
constructing a signature stream by designating first two bytes of the signature stream as the height and width values;
appending the bitmap header to the signature stream; and
converting the signature stream into an ASCII signature format.

Typically, the step of decoding the encoded signature at a POS terminal includes the following steps:
converting the encoded signature into an array of binary data;
determining the height and width of the converted image by reading the first two bytes that denote the height and width of the image respectively;
reading the bitmap header and constructing a temporary image buffer having one byte representing one pixel;
initializing the temporary image buffer with zeros such that all pixels by default are white in color;
reading the bitmap header and determining the positions of the pixels that need to be initialized with the value one;
initializing such pixels with numeral one, so that they turn black in color; and
generating a monochrome image representing payment card holder's signature.

Preferably, the step of displaying the decoded signature includes the step of transmitting the decoded signature to the financial institution associated with a corresponding payment card for verification.

### BRIEF DESCRIPTION OF THE ACCOMPANYING DRAWINGS

The disclosure will now be described with reference to the accompanying drawings, in which:

FIG. 1 illustrates a schematic of the system for displaying users' signature for authenticating financial transactions in accordance with this disclosure; and

FIG. 2 is a flowchart showing the step involved in displaying users' signature for authenticating financial transactions in accordance with this disclosure.

### DETAILED DESCRIPTION

The system for displaying users' signature on POS terminals for authenticating financial transactions will now be described in detail with reference to the accompanying drawings. The description and drawings do not limit the scope and ambit of the disclosure and are provided purely by way of example and illustration.

The conventional POS terminals do not have the facility to authenticate financial transactions and are thus vulnerable to security risks. The conventional POS terminals only act as a communication medium between the payment card holder and the financial institutions like banks for debit of a transactional amount.

Therefore, in order to overcome the security issues associated with the financial transactions performed on a POS terminal, the present disclosure envisages a system for displaying payment card holder's signature on the display screen of the POS terminal and permitting a financial transaction only after the verification of the displayed signature.

The proposed system includes a server which captures an image of the handwritten signature of a user at the time of registration of a payment card. This signature is then processed at a server and encoded into a format convenient for storage and transmission. The server stores this encoded signature corresponding to a user's payment card number and fetches it, at the time of a transaction to transmit to a POS terminal.

The POS terminals are embedded with a customized application which enables the terminals to communicate with the server to receive the encoded signature and efficiently decode it. The application also enables the terminals to communicate with the payment card issuing financial institutions for verification of the decoded signature.

The POS terminals display the decoded signature only in the event that the signature fetched from the server matches with the signature available with the financial institution for a particular payment card number.

In accordance with this disclosure, the display of the user's signature on the POS terminal not only acts as a secure access image for users to guarantee a secure payment channel but also proves the authenticity of the remote application servers associated with the financial institutions. Thereby, the display of the user's signature on the POS terminals makes the terminals invulnerable to security risks.

Moreover, the display of the signature on the POS terminal also enables the operator to verify the signature of the payment card holder to ensure that the card belong to the payment card holder itself.

Only on receiving a confirmation from the financial institution, the operator and the payment card holder/user the financial transaction takes place, thus, making the POS terminals secure and reliable for conducting financial transactions.

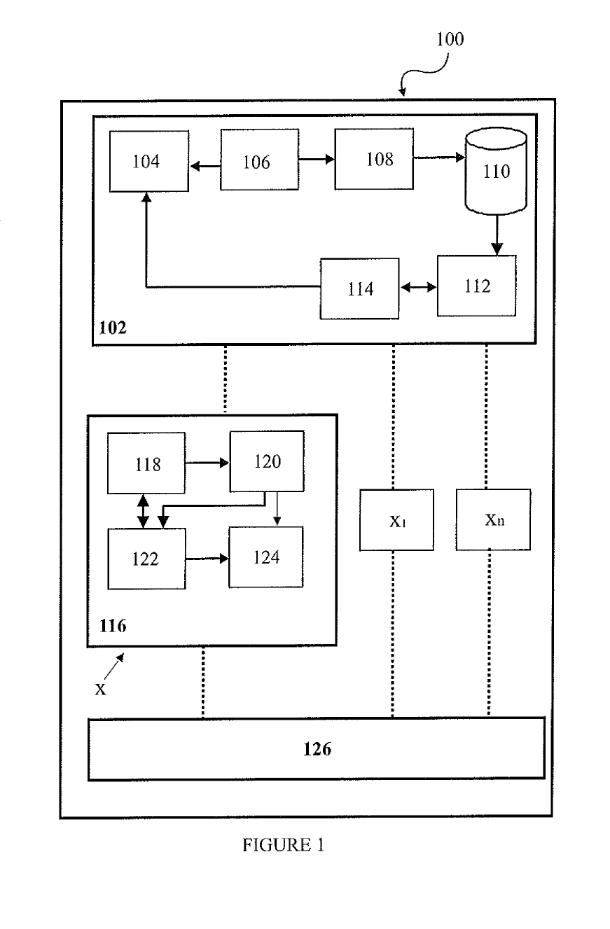

Referring to the accompanying drawings, FIG. 1 illustrates a schematic of the system 100 for displaying users' signature for authenticating financial transactions, wherein each of the users are in possession of at least one payment card issued by a financial institution for conducting the financial transactions.

The system 100 includes a server 102 which encodes and stores an image of a handwritten signature captured at the time of registration of a user's payment card. The server 102 retrieves and transmits the encoded signature, at the time of a transaction, on receiving a request corresponding to a payment card number.

The system 100 also includes a plurality of POS terminals X, X₁ to Xₙ collectively represented by 116 which remotely communicate with the server 102 and a plurality of payment card issuing financial institutions' application servers 126. The POS terminals 116 are embedded with a customized application which facilitates the communication between the server 102 and application servers 126. The embedded application also enables the POS terminal 116 to decode the encoded signature received from the server 102 for display on the POS terminal in the event that the signature is verified by a corresponding application server 126.

The server 102 includes conversion means 104 to convert the handwritten signature image into a monochrome image. A transceiver unit 114 captures the handwritten signature image for said conversion means 104. The conversion means 104 accesses the handwritten signature image and scans the image from ‘top left corner’ to ‘bottom right corner’ and subsequently compares the value of every pixel of the image with a threshold value. The pixels whose value is greater than the threshold value are marked in black and the pixels whose value is lesser than the threshold value are marked in white. In accordance with this disclosure, the threshold value can be changed at the time of capturing the signature so as to convert the image to monochrome as accurately as possible without distorting the signature. Subsequently, the pixels of the monochrome image are represented by a bit having a Boolean value (either 0 or 1). If a pixel of the monochrome image has the value ‘1’, it means that it is black in color and if the pixel has the value ‘0’, it means that it is white in color.

The monochrome image created by the conversion means 104 is given to bitmap header creation means 106. The bitmap header creation means 106 integrates eight consecutive bits, where each bit represents a monochrome pixel and subsequently converts the eight bit sequence into a byte value. If the obtained byte value is ‘0’, it means that none of the pixels in the bit sequence are black in color, but if the byte value is non-zero, it means that at least one of the pixels in the bit sequence is black in color. Subsequently a bitmap header is created by a bitmap header creation means 106. The bitmap header created by the bitmap header creation means 106 has the number of bits equal to the number of bytes contained in the pixel sequence generated by the conversion means 104. If a particular byte value is non-zero, the corresponding bit in the byte sequence is set to ‘1’, otherwise it is set to ‘0’.

In accordance with the present disclosure, the server 102 also includes encoding means 108. The encoding means 108 receives the bitmap header from the bitmap header creation means 106 and subsequently constructs a signature stream. The first two bytes of the signature stream indicate the height and width of the signature stream and the rest of the contents of signature stream is the bitmap header received from the bitmap header creation means 106. The signature stream constructed by the encoding means 108 is typically in binary form and is subsequently converted into ASCII format using an algorithm such as base64 algorithm.

The signature stream in the ASCII signature format thus created is stored in a central repository 110. Whenever a transaction is performed on a POS terminal 116, the POS terminal 116 sends a request to the server 102 for retrieval of the ASCII signature format that corresponds to the user using the payment card. The transceiver unit 114 receives the request corresponding to a user's payment card number and notifies fetching means 112. The fetching means 112 validates the request and subsequently fetches the corresponding ASCII signature format from the central repository 110 and transmits it to the POS terminal 116 through the transceiver unit 114.

The POS terminal 116 includes a communication unit 118 which receives the ASCII signature format from the server 102 on transmitting a user's payment card number. The payment card number is typically transmitted when an operator swipes the payment card on the terminal 116. The application on the POS terminal 116 automatically instructs the communication unit 118 to transmit the card number directly to the server 102.

The POS terminal 116 also includes decoding means 120 which has a temporay image buffer (not shown in the figures) to facilitate in the conversion of the ASCII signature format into an array of binary data and further into a monochrome image representing a payment card holder's signature. The decoding means 120 decodes the received the ASCII signature format into a monochrome image using the following steps:
converting the ASCII signature format image into array of binary data;
determining the height and width of the converted image by reading the first two bytes that denote the height and width of the image respectively;
reading the bitmap header and constructing the temporary image buffer having one byte representing one pixel;
initializing the temporary image buffer with zeros, meaning that all the pixels by default are white in color;
reading the bitmap header and determining the positions of the pixels that need to be initialized with the value one;
initializing such pixels with numeral one, so that they turn black in color; and
generating a monochrome image representing payment card holder's signature.

The monochrome image is first passed to verification means 122 which via the communication unit 118 transmits the monochrome image to a corresponding financial institution 126 for verification along with the user's payment card number. The communication unit 118 receives a verification response from a corresponding financial institution 126 and passes it to the verification means 122. The verification means 122 prompts display means 124 to display the monochrome image in the event that the verification response is positive.

In accordance with the present disclosure, the transceiver unit 114 and the communication unit 118 use at least one ISO8583 message which includes user-defined fields adapted to carry the ASCII stream format image between the server 102, the POS terminals 116 and the financial institutions' application server 126.

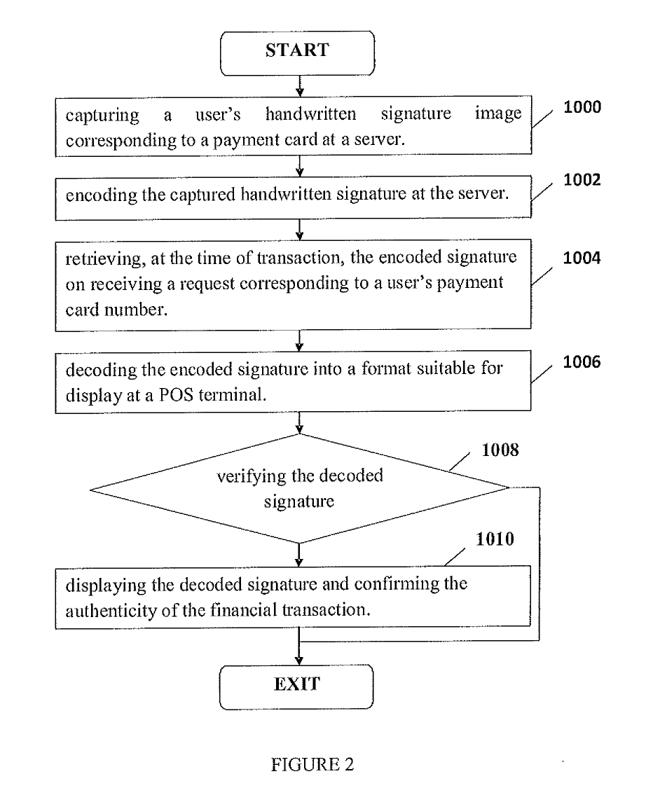

In accordance with this disclosure there is provided a method for displaying users' signature on a POS terminal for authenticating financial transactions, wherein each of the users are in possession of at least one payment card issued by a financial institution for conducting the financial transactions, the method comprising the following steps as seen in FIG. 2:
capturing a user's handwritten signature image corresponding to a payment card at a server 1000;
encoding the captured handwritten signature at the server 1002;
retrieving, at the time of transaction, the encoded signature on receiving a request corresponding to a user's payment card number 1004;
decoding the encoded signature into a format suitable for display at a POS terminal 1006;
verifying the decoded signature 1008;
displaying the decoded signature and confirming the authenticity of the financial transaction in the event that the decoded signature is verified 1010.

In accordance with this disclosure, the step of encoding the captured handwritten signature includes the following steps:
converting the captured handwritten signature into a monochrome image by comparing each pixel value in the handwritten signature image with a predetermined threshold value;
grouping at least eight consecutive bits in the monochrome image for deriving a byte value for creating a bitmap header; and
constructing a signature stream by designating first two bytes of the signature stream as the height and width values;
appending the bitmap header to the signature stream; and
converting the signature stream into an ASCII signature format.

Typically, the step of decoding the encoded signature at a POS terminal includes the following steps:
converting the encoded signature into an array of binary data;
determining the height and width of the converted image by reading the first two bytes that denote the height and width of the image respectively;
reading the bitmap header and constructing a temporary image buffer having one byte representing one pixel;
initializing the temporary image buffer with zeros such that all pixels by default are white in color;
reading the bitmap header and determining the positions of the pixels that need to be initialized with the value one;
initializing such pixels with numeral one, so that they turn black in color; and
generating a monochrome image representing payment card holder's signature.

Preferably, the step of displaying the decoded signature includes the step of transmitting the decoded signature to the financial institution associated with a corresponding payment card for verification.

### TECHNICAL ADVANTAGES

The technical advancements of the present disclosure include the following:
present disclosure provides the facility of using signatures of payment card holders for authenticating financial transactions;
present disclosure provides a system that verifies the signature displayed on a POS terminal with the original signature before approving a financial transaction;
present disclosure displays the signature of the payment card users as a secure access image on a POS terminal, at the time of performing a financial transaction to confirm the authenticity of the financial transaction;
present disclosure provides a system that can be easily integrated with existing network for providing safer and secured financial transactions; and
present disclosure provides a system that facilitates conversion of customer's signatures into monochrome format without creating substantial operational overheads.

While considerable emphasis has been placed herein on the particular features of this disclosure, it will be appreciated that various modifications can be made, and that many changes can be made in the preferred embodiment without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A system for displaying users' signature for authenticating financial transactions, wherein each of the users are in possession of at least one payment card issued by a financial institution for conducting the financial transactions, said system comprising:
a server adapted to encode and store an image of a handwritten signature captured corresponding to a user's payment card and further adapted to retrieve and transmit the encoded signature on receiving a request corresponding to a user's payment card number; and
a plurality of POS terminals co-operating with said server and embedded with a customized application, said PUS terminals adapted to receive said encoded signature in response to a payment card number transmitted for a user and further adapted to decode, display said encoded signature and confirm the authenticity of the financial transaction in the event that the decoded signature is verified.

2. The system as claimed in claim 1, wherein said server is adapted to encode said handwritten signature image using a base64 algorithm.

3. The system as claimed in claim 1, wherein said request corresponding to a user's payment card number is raised by swiping the payment card at said PUS terminal.

4. The system as claimed in claim 1, wherein said server, each of said POS terminals and the financial institutions associated with the payment cards co-operate with each other using at least one ISO8583 based communication format.

5. The system as claimed in claim 1, wherein said server comprises:
conversion means adapted to convert said handwritten signature image into a monochrome image by comparing each pixel value in said handwritten signature image with a predetermined threshold value;
bitmap header creation means adapted to receive and group at least eight consecutive bits in said monochrome image to derive a byte value and further adapted to create a bitmap header wherein the number of bits in said bitmap header equal the number of bytes contained in said monochrome image;
encoding means adapted to receive said bitmap header and subsequently construct a signature stream and further adapted to designate first two bytes of said signature stream as the height and width values and still further adapted to append said bitmap header to said signature stream and convert said signature stream into an ASCII signature format;
a central repository adapted to store said ASCII signature format corresponding to a payment card number associated with a user;
fetching means adapted to receive a request corresponding to a user's payment card number and further adapted to fetch a corresponding ASCII signature format from said central repository; and
a transceiver unit adapted to receive said handwritten signature image for said conversion means and further adapted to receive a request corresponding to a user's payment card number and subsequently transmit said ASCII signature format received from said fetching means to a corresponding POS terminal.

6. The system as claimed in claim 1, wherein said POS terminal comprises:
a communication unit adapted to receive said ASCII signature format from said server on transmitting a user's payment card number and further adapted to receive a verification response from a corresponding financial institution on transmitting a user's payment card number and a monochrome equivalent of the ASCII signature format;
decoding means having a temporary buffer to convert said ASCII signature format into an array of binary data and further adapted to convert said array of binary data into a monochrome image representing a payment card holder's signature;
verification means adapted to transmit said monochrome image to a corresponding financial institution for verification along with the user's payment card number; and
display means adapted to display said monochrome image in the event that said verification response is positive.

7. A method for displaying users' signature for authenticating financial transactions, wherein each of the users are in possession of at least one payment card issued by a financial institution for conducting financial transactions, said method comprising the following steps:
capturing a handwritten signature image corresponding to payment card holder at a server;
encoding the captured handwritten signature at said server;
retrieving, at the time of transaction, the encoded signature on receiving a request corresponding to a user's payment card number;
decoding said encoded signature into a format suitable for display at a POS terminal; and
displaying the decoded signature and confirming the authenticity of the financial transaction in the event that the decoded signature is verified.

8. The method as claimed in claim 7, wherein the step of encoding the captured handwritten signature includes the following steps:
converting the captured handwritten signature into a monochrome image by comparing each pixel value in said handwritten signature image with a predetermined threshold value;
grouping at least eight consecutive bits in said monochrome image for deriving a byte value for creating a bitmap header; and
constructing a signature stream by designating first two bytes of said signature stream as the height and width values;
appending said bitmap header to said signature stream; and
converting said signature stream into an ASCII signature format.

9. The method as claimed in claim 7, wherein the step of decoding said encoded signature at a POS terminal includes the following steps:
converting the encoded signature into an array of binary data;
determining the height and width of the converted image by reading the first two bytes that denote the height and width of the image respectively;
reading the bitmap header and constructing a temporary image buffer having one byte representing one pixel;
initializing the temporary image buffer with zeros such that all pixels by default are white in color;
reading the bitmap header and determining the positions of the pixels that need to be initialized with the value one;
initializing such pixels with numeral one, so that they turn black in color; and
generating a monochrome image representing payment card holder's signature.

10. The method as claimed in claim 7, wherein the step of displaying the decoded signature includes the step of transmitting said decoded signature to the financial institution associated with a corresponding payment card for verification.
